(19) United States
(12) Patent Application Publication
(10) Pub. No.: US 2025/0317069 A1
(43) Pub. Date: Oct. 9, 2025

(54) CIRCUIT-INTEGRATED DUAL OUTPUT LOW DC-DC CONVERTER

(71) Applicants: Hyundai Motor Company, Seoul (KR); Kia Corporation, Seoul (KR)

(72) Inventors: Gyungseok Han, Hwaseong-si (KR); Wonseok Jin, Hwaseong-si (KR); Sang Don Lee, Hwaseong-si (KR); Tae Woo Kim, Hwaseong-si (KR); Se-Hyuck Wi, Hwaseong-si (KR); HoonHa Hwang, Hwaseong-si (KR)

(21) Appl. No.: 18/934,940

(22) Filed: Nov. 1, 2024

(30) Foreign Application Priority Data
Apr. 8, 2024 (KR) 10-2024-0047372

(51) Int. Cl. H02M 3/335; B60L 53/22; H02M 1/00

(52) U.S. Cl. CPC H02M 3/33592; B60L 53/22; H02M 1/009; B60L 2210/10

(57) ABSTRACT

An embodiment circuit-integrated dual output low direct current to direct current (dc-dc) converter (LDC) includes a transformer including a primary coil of an input circuit and a secondary coil of an output circuit, the secondary coil including a first coil and a second coil, a switching circuit connected to the primary coil and a high-voltage battery, a first rectifier circuit connected to the first coil and configured to provide a first voltage, and a second rectifier circuit connected to the second coil and configured to provide a second voltage.

### CROSS-REFERENCE TO RELATED APPLICATIONS

This application claims the benefit of Korean Patent Application No. 10-2024-0047372, filed on Apr. 8, 2024, which application is hereby incorporated herein by reference.

### TECHNICAL FIELD

The present disclosure relates to a circuit-integrated dual output low direct current to direct current (dc-dc) converter (LDC).

### BACKGROUND

A commercial eco-friendly vehicle requires dual power (24/12 V) because the vehicle has a mixture of a 24 V controller (for general driving) and a 12 V controller (for autonomous driving and passenger car change over (C/O)).

A general power configuration of the commercial eco-friendly vehicle may use a 24 V electric load (12V+12V batteries) that is connected to the rear of a 24 V output low direct current to direct current (dc-dc) converter (LDC) with an 800 V power input from a high-voltage battery and a separate battery equalizer (BEQ) or a low-voltage converter to generate 12 V.

The commercial vehicle power requires a double conversion (800V→24V→12V), which may cause lower efficiency and more individual products.

When using each high-voltage LDC (24/12 V) to generate individual power, it still requires more individual products although there is no lower efficiency caused by the double conversion.

Although allowing dual output in one housing, an integrated power supply device uses separate circuits to thus require the same number of necessary components compared to an individual power supply method.

### SUMMARY

The present disclosure relates to a circuit-integrated dual output low direct current to direct current (dc-dc) converter (LDC). Particular embodiments relate to a circuit-integrated dual output LDC in which a low-voltage power system is efficiently managed by a dual output LDC in one housing.

Embodiments of the present disclosure provide a circuit-integrated dual output low direct current to direct current (dc-dc) converter (LDC) capable of reducing the number of components by integrating internal circuits to each other to thus use one housing and outputting dual voltages to a first low-voltage battery and a second low-voltage battery by reducing a voltage from a high-voltage battery.

According to an embodiment, provided is a circuit-integrated dual output low direct current to direct current (dc-dc) converter (LDC) that includes a transformer including a primary coil of an input circuit and a secondary coil of an output circuit, the secondary coil including a first coil and a second coil, a switching circuit connected to the primary coil and a high-voltage battery, a first rectifier circuit connected to the first coil to thus provide a first voltage, and a second rectifier circuit connected to the second coil to thus provide a second voltage.

The first rectifier circuit and the second rectifier circuit may be synchronous rectifier circuits.

The first coil and the second coil may each have a center-tap structure.

The switching circuit may have a full-bridge structure.

The first voltage may be 12 V to 14 V, and the second voltage may be 24 V to 28 V.

The first coil and the second coil may have different numbers of turns.

The transformer may have a flyback structure.

The first voltage and the second voltage may be integrated and controlled through one control input that is input from a controller through one switching circuit.

The transformer may output dual voltages of the first voltage and the second voltage to the first rectifier circuit and the second rectifier circuit by reducing an input voltage of the high-voltage battery through the switching circuit.

Each of a maximum capacity of first power applied to a first load using the first voltage and a maximum capacity of second power applied to a second load using the second voltage may be variably determined.

As set forth above, the circuit-integrated dual output LDC according to an embodiment of the present disclosure may reduce the number of components and reduce its size/weight through the integrated use of the primary switching circuit and the transformer.

The circuit-integrated dual output LDC according to an embodiment of the present disclosure may flexibly respond to vehicle architecture development by reducing design costs through the controller integration.

The circuit-integrated dual output LDC according to an embodiment of the present disclosure may reduce the unit cost and size and easily configure the cooling by reducing the numbers of the switching elements and the magnetic materials through the circuit integration.

### BRIEF DESCRIPTION OF THE DRAWINGS

FIG. 1 shows an in-vehicle system including a circuit-integrated dual output low direct current to direct current (dc-dc) converter (LDC) according to an embodiment of the present disclosure.

FIG. 2 is a view for explaining the circuit-integrated dual output LDC according to an embodiment of the present disclosure.

### DETAILED DESCRIPTION OF ILLUSTRATIVE EMBODIMENTS

Hereinafter, embodiments of the present disclosure are described in detail with reference to the accompanying drawings for those skilled in the art to which the present disclosure pertains to easily practice embodiments of the present disclosure. The present embodiments may be modified in various different forms and are not limited to the embodiments described in the specification. In addition, in the drawings, portions unrelated to the description are omitted to clearly describe embodiments of the present disclosure, and similar portions are denoted by similar reference numerals throughout the specification.

Through the present specification and claims, unless explicitly described otherwise, “including” any components will be understood to imply the inclusion of another component rather than the exclusion of another component. Terms including ordinal numbers such as “first,” “second,” and the like may be used to describe various components. However, these components are not limited by these terms. The terms are used only to distinguish one component from another component.

Terms such as “˜part,” “˜er/or,” and “module” described in the specification may refer to a unit capable of processing at least one function or operation described in the specification, which may be implemented as hardware, a circuit, software, or a combination of hardware or a circuit and software.

Hereinafter, the embodiments of the present disclosure are described with reference to the accompanying drawings.

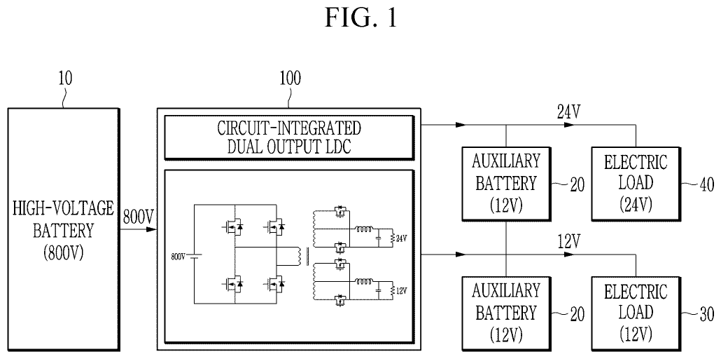

FIG. 1 shows an in-vehicle system including a circuit-integrated dual output low direct current to direct current (dc-dc) converter (LDC) according to an embodiment of the present disclosure.

Referring to FIG. 1, a system for supplying power to low-voltage electrical equipment in a vehicle may include a high-voltage battery 10, an auxiliary battery 20, electric loads 30 and 40, and a circuit-integrated dual output LDC 100.

The high-voltage battery 10 may be a high-voltage battery of 400 V to 1000 V for charging the vehicle and may include, for example, an 800 V battery.

The auxiliary battery 20 may include a 12V auxiliary battery. The auxiliary battery 20 may be charged through the circuit-integrated dual output LDC 100.

The electrical loads 30 and 40 may include a 12 V electrical load 30 using 12 V and a 24 V electrical load 40 using 24 V.

The 24 V electric load 40 may include the electrical equipment such as a wiper, a lamp, and a controller. The 12V electric load 30 may include the electrical equipment such as autonomous driving and hydrogen-related electric loads.

Power for the electric loads 30 and 40 may be supplied through the circuit-integrated dual output LDC 100.

The circuit-integrated dual output LDC 100 may convert a high voltage of the high-voltage battery 10 in the vehicle to a low voltage of 24 V or 12 V and supply the power to the 24 V or 12 V electrical equipment and charge its battery.

Compared to an existing LDC, the circuit-integrated dual output LDC 100 may integrate a circuit connected to the 12 V electric load 30 and a circuit connected to the 24 V electric load 40 into one switching circuit through one transformer.

The circuit-integrated dual output LDC 100 may integrate the transformer and a primary switching circuit connected to a plurality of secondary rectifier circuits into one. That is, the circuit-integrated dual output LDC 100 may include the plurality of secondary rectifier circuits, one transformer, and one switching circuit.

Although having an operation feature similar to that of an existing full-bridge center tap circuit, the circuit-integrated dual output LDC 100 may add a secondary tap (secondary coil or wire) to output multiple voltages of 24 V (target: 28 V) and 12 V (target: 14 V) based on a turns ratio of the transformer.

The circuit-integrated dual output LDC 100 may use a primary switch and the transformer, integrated to each other, thus minimizing lower efficiency caused by the number of switches and a magnetic material and minimizing an area and easily configuring lines when configuring single-product cooling.

The circuit-integrated dual output LDC 100 may reduce the number of magnetic materials (main transformers/secondary inductors) compared to an existing product through this integrated housing.

The circuit-integrated dual output LDC 100 may reduce the number of switching elements compared to an existing model.

The circuit-integrated dual output LDC 100 may reduce the number of input/output sensors and filter circuits compared to the existing model.

In addition, the circuit-integrated dual output LDC 100 may use a 24 V control power for full control and use a 12 V control power for indirect control based on main control. For example, the 12 V control power may only activate its own fault diagnosis. The circuit-integrated dual output LDC 100 may achieve simplified control and improved reliability.

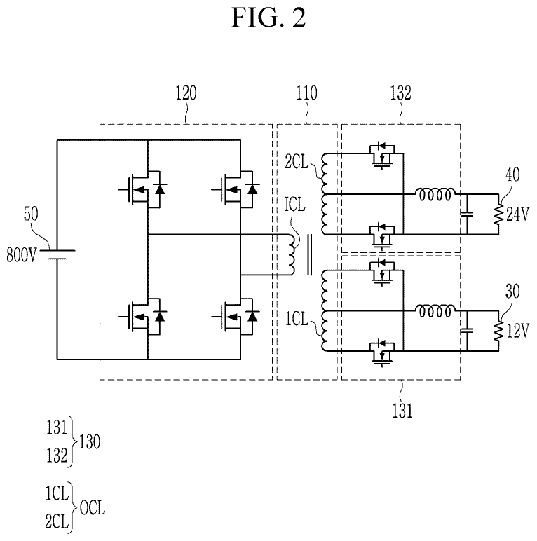

That is, the circuit-integrated dual output LDC 100 may provide the dual output in a single housing through the integrated circuit and achieve the improved reliability by simplifying its control through cooperative control. This configuration is described in more detail with reference to FIG. 2.

FIG. 2 is a view for explaining the circuit-integrated dual output LDC according to an embodiment of the present disclosure.

Referring to FIG. 2, the circuit-integrated dual output LDC 100 may include a transformer 110, a switching circuit 120, and a rectifier circuit 130.

The transformer 110 may increase or reduce a voltage of an input circuit based on the number of turns of a coil and output the voltage to an output circuit. For example, the transformer 110 may reduce a voltage of the 800 V high-voltage battery 10 of the input circuit and provide the voltage to each of the 12 V electric load 30 and the 24 V electric load 40 of the output circuit.

The transformer 110 may include a primary coil ICL of the input circuit and a secondary coil OCL of the output circuit. The secondary coil OCL may include a first coil 1CL and a second coil 2CL.

The first coil 1CL and the second coil 2CL may be separated from each other. The first coil 1CL and the second coil 2CL may have different numbers of turns.

The transformer 110 may have a flyback structure.

The first coil 1CL and the second coil 2CL may each have a center-tap structure.

The transformer 110 may output dual voltages of a first voltage and a second voltage to a first rectifier circuit 131 and a second rectifier circuit 132 by reducing an input voltage of the high-voltage battery 10 through the switching circuit 120.

The first voltage may be 12 V to 14 V, and the second voltage may be 24 V to 28 V.

The transformer 110 may have a center tap two-winding transformer integrated structure. It is thus possible to reduce the number of magnetic materials in the transformer compared to that of the existing model.

The switching circuit 120 may be connected to the input circuit or primary coil of the transformer 110.

The switching circuit 120 may be connected to the primary coil ICL. The switching circuit 120 may be connected to the high-voltage battery 10 (see FIG. 1). The switching circuit 120 may use the high-voltage battery 10 as power 50 and output the high voltage to the transformer 110.

The switching circuit 120 may alternately switch the input voltage to thus convert the voltage, thereby transferring the same to the transformer 110.

The switching circuit 120 may have a full-bridge structure.

The switching circuit 120 may include a plurality of transistors. The plurality of transistors may include metal oxide semiconductor field effect transistors (MOSFETs).

The switching circuit 120 may convert a DC high voltage of the power 50 into an alternating current (AC) voltage through the plurality of transistors and transfer the same to the transformer 110.

One switching circuit 120 may be provided to the primary coil ICL to thus integrate and control the plurality of secondary circuits. It is thus possible to reduce the number of power semiconductors compared to the existing model.

The switching circuit 120 may further include a choke coil and/or a capacitor. The choke coil may be connected in series with the power 50. The capacitor may be connected in parallel with the power 50.

The rectifier circuit 130 may be connected to the output circuit or the secondary coil OCL of the transformer 110. That is, the rectifier circuit 130 may be connected to the secondary coil OCL.

The rectifier circuit 130 may rectify the AC voltage whose frequency feature is converted into the DC voltage and filter the same through the capacitor.

The rectifier circuit 130 may include the first rectifier circuit 131 and the second rectifier circuit 132. The first rectifier circuit 131 and the second rectifier circuit 132 may be independent circuits.

The first rectifier circuit 131 may be connected to the first coil 1CL to thus provide the first voltage. The second rectifier circuit 132 may be connected to the second coil 2CL to thus provide the second voltage.

The first rectifier circuit 131 and the second rectifier circuit 132 may be synchronous rectifier circuits. That is, the first rectifier circuit 131 and the second rectifier circuit 132 may each include the transistor instead of a diode.

The first rectifier circuit 131 and the second rectifier circuit 132 may each include the choke coil and the capacitor.

The first rectifier circuit 131 may be connected to the first electric load 30. That is, the first rectifier circuit 131 may rectify and provide the reduced voltage to the first electric load 30.

The second rectifier circuit 132 may be connected to the second electric load 40. The second rectifier circuit 132 may rectify and provide the reduced voltage to the second electric load 40.

The first voltage and the second voltage may be integrated and controlled through one control input that is input from the controller through one switching circuit 120.

For example, the circuit-integrated dual output LDC 100 may fully control the second voltage of 24 V as the main control and indirectly control the first voltage of 12 V based on the main control.

That is, the circuit-integrated dual output LDC 100 may perform sensing using a 24 V line for the main control and supply a stable low voltage through synchronous rectification (secondary field-effect transistor (FET) control) using a 12 V line adjusted to the turns ratio of the secondary coil for the target voltage of 14V.

Each of the maximum capacity of first power applied to the first load using the first voltage and the maximum capacity of second power applied to the second load using the second voltage may be variably determined.

For example, the circuit-integrated dual output LDC 100 may organically change the maximum capacity of each of the first electric load 30 and the second electric load 40 through the circuit integration.

In the existing model, it is not possible to use the LDCs beyond their respective capacities when separately utilizing the LDC for 24 V (2 kW) and the LDC for 12 V (2 kW).

On the other hand, it is possible to use the circuit-integrated dual output LDC 100 by distributing the power at 24 V (1 kW) and 12 V (3 kW), for example, when allocating a total power of 4 kW between 24 V and 12 V through the integrated control and the dual outputs.

That is, the circuit-integrated dual output LDC 100 may enhance the scalability of 24 V and 12 V controls through the secondary synchronous rectification and the center tap.

A commercial eco-friendly vehicle may be equipped with a total of three batteries, including two 12 V batteries (24 V batteries) connected in series for a general load and one 12 V battery for a load such as autonomous driving and a hydrogen controller.

Here, the low-voltage battery may function as a kind of damper, and the precision or speed of control may not be very important.

The circuit-integrated dual output LDC 100 may have greater usability than the existing LDC in that the circuit-integrated dual output LDC 100 may perform the sensing using the 24 V line for the main control and supply the stable low voltage through the synchronous rectification (secondary field-effect transistor (FET) control) using the 12 V line adjusted to the turns ratio of the secondary coil for the target voltage of 14 V.

Although exemplary embodiments of the present disclosure have been described in detail hereinabove, the scope of the embodiments of the present disclosure is not limited thereto. That is, various modifications and alterations made by those skilled in the art to which the present disclosure pertains by using a basic concept of embodiments of the present disclosure as defined in the following claims also fall within the scope of the embodiments of the present disclosure.

What is claimed is:

1. A circuit-integrated dual output low direct current to direct current (dc-dc) converter (LDC), the LDC comprising:
a transformer comprising a primary coil of an input circuit and a secondary coil of an output circuit, the secondary coil comprising a first coil and a second coil;
a switching circuit connected to the primary coil and a high-voltage battery;
a first rectifier circuit connected to the first coil and configured to provide a first voltage; and
a second rectifier circuit connected to the second coil and configured to provide a second voltage.

2. The LDC of claim 1, wherein the first rectifier circuit and the second rectifier circuit comprise synchronous rectifier circuits.

3. The LDC of claim 1, wherein the first coil and the second coil each have a center-tap structure.

4. The LDC of claim 1, wherein the switching circuit has a full-bridge structure.

5. The LDC of claim 1, wherein the first voltage is 12 V to 14 V and the second voltage is 24 V to 28 V.

6. The LDC of claim 1, wherein the first coil and the second coil have different numbers of turns.

7. The LDC of claim 1, wherein the transformer has a flyback structure.

8. The LDC of claim 1, wherein the first voltage and the second voltage are integrated and configured to be controlled through one control input that is input from a controller through one switching circuit.

9. The LDC of claim 1, wherein the transformer is configured to output dual voltages of the first voltage and the second voltage to the first rectifier circuit and the second rectifier circuit by reducing an input voltage of the high-voltage battery through the switching circuit.

10. The LDC of claim 1, wherein each of a maximum capacity of a first power applied to a first load using the first voltage and a maximum capacity of a second power applied to a second load using the second voltage is variably determined.

11. A system for supplying power to low-voltage electrical equipment in a vehicle, the system comprising:
a high-voltage battery configured to charge the vehicle;
first and second auxiliary batteries;
first and second electric loads coupled to the first and second auxiliary batteries, respectively; and
a circuit-integrated dual output low direct current to direct current (dc-dc) converter (LDC) configured to charge the first and second auxiliary batteries), the LDC comprising:
a transformer comprising a primary coil of an input circuit and a secondary coil of an output circuit, the secondary coil comprising a first coil and a second coil;
a switching circuit connected to the primary coil and the high-voltage battery;
a first rectifier circuit connected to the first coil and configured to provide a first voltage; and
a second rectifier circuit connected to the second coil and configured to provide a second voltage.

12. The system of claim 11, wherein the first rectifier circuit and the second rectifier circuit comprise synchronous rectifier circuits.

13. The system of claim 11, wherein the first coil and the second coil each have a center-tap structure.

14. The system of claim 11, wherein the switching circuit has a full-bridge structure.

15. The system of claim 11, wherein the first voltage is 12 V to 14 V and the second voltage is 24 V to 28 V.

16. The system of claim 11, wherein the first coil and the second coil have different numbers of turns.

17. The system of claim 11, wherein the transformer has a flyback structure.

18. The system of claim 11, wherein the first voltage and the second voltage are integrated and configured to be controlled through one control input that is input from a controller through one switching circuit.

19. The system of claim 11, wherein the transformer is configured to output dual voltages of the first voltage and the second voltage to the first rectifier circuit and the second rectifier circuit by reducing an input voltage of the high-voltage battery through the switching circuit.

20. The system of claim 11, wherein each of a maximum capacity of a first power applied to the first electric load using the first voltage and a maximum capacity of a second power applied to the second electric load using the second voltage is variably determined.
